(19) United States
(12) Patent Application Publication
(10) Pub. No.: US 2014/0301798 A1
(43) Pub. Date: Oct. 9, 2014

(54) CUTTING TOOL AND METHOD OF MANUFACTURING THE SAME

(71) Applicant: Yoshifumi Koike, Higashiomi-shi (JP)

(72) Inventor: Yoshifumi Koike, Higashiomi-shi (JP)

(73) Assignee: Kyocera Corporation, Kyoto-shi, Kyoto (JP)

(21) Appl. No.: 14/001,164

(22) PCT Filed: Dec. 27, 2011
(86) PCT No.: PCT/JP2011/080254

§ 371 Date: Nov. 1, 2013

(30) Foreign Application Priority Data
Feb. 23, 2011 (JP) 2011-037191
Feb. 23, 2011 (JP) 2011-037192

(51) Int. Cl. B23B 51/02; B23P 15/32

(52) U.S. Cl. CPC B23B 51/02; B23P 15/32; B23B 2251/24
USPC 408/229; 76/108.6

(57) ABSTRACT

A cutting tool according to an embodiment of the invention includes: a column-like shaped body having a cutting edge located at a front end part thereof and a flute which is located at an outer peripheral part thereof and is continuous with the cutting edge; a front taper connected to a rear end part of the body and having a larger diameter as separating from the body; a column-like shaped step connected to a rear end part of the front taper and having a larger diameter than the body; a rear taper connected to a rear end part of the step and having a larger diameter as separating from the step; a column-like shaped shank connected to a rear end part of the rear taper and having a larger diameter than the step; and a front connection member located in a region including the front taper and the step.

### FIELD OF INVENTION

The present invention relates to a cutting tool and a method of manufacturing the cutting tool.

### BACKGROUND

As a cutting tool, Japanese Examined Utility Model (Registration) Application Publication No. 3104272 discloses a drill that allows a shank and a body to be made of different materials by employing a structure that connects the shank and the body to each other. This publication also discloses a structure having two oblique conoid-shaped basal parts on the body.

However, this drill is configured to dispose a connection portion between the shank and the body, and hence the diameter of a member for the body used for replacement is relatively large. As a result, a long time is required to form the body provided with round conoid-shaped basal parts and a drill head part by grinding the member for the body, and material cost is wasted because a large size portion is removed by machining.

### SUMMARY

An object of the present invention is to provide a cutting tool and a method of manufacturing the cutting tool, which are capable of reducing machining time and material cost of the body.

A cutting tool according to an embodiment of the invention includes: a column-like shaped body having a cutting edge located at a front end part thereof and a flute which is located at an outer peripheral part thereof and is continuous with the cutting edge; a front taper connected to a rear end part of the body and having a larger diameter as separating from the body; a column-like shaped step connected to a rear end part of the front taper and having a larger diameter than the body; a rear taper connected to a rear end part of the step and having a larger diameter as separating from the step; a column-like shaped shank connected to a rear end part of the rear taper and having a larger diameter than the step; and a front connection member located in a region including the front taper and the step.

A method of manufacturing a cutting tool according to an embodiment of the present invention includes: (i) preparing a cutting tool base comprising a column-like shaped body having a cutting edge located at a front end part thereof and a flute which is located at an outer peripheral part thereof and is continuous with the cutting edge, a column-like shaped step connected to a rear end part of the body and having a larger diameter than the body, a column-like shaped shank connected to a rear end part of the step and having a larger diameter than the step, and a first front connection member located in a region including the body and the step; (ii) heating the first front connection member at a temperature T1 of a melting point thereof or higher; (iii) separating from each other oppositely located portions of the first front connection member in a state that a temperature of the first front connection member is the melting point or higher; (iv) disposing a body member at one of the portions separated from each other which is located closer to the shank, by interposing a second front connection member between the body member and the one of the portions; (v) heating the second front connection member at a temperature T2 of a melting point thereof or higher; and (vi) cooling the second front connection member at a temperature T3 below the melting point thereof after heating the second front connection member.

In the cutting tool of the embodiment of the present invention, the step is disposed between the body and the shank and the two tapers (the front taper and the rear taper) exist therebetween, and the front connection member is located in the region whose diameter is smaller than the diameter of the shank, namely, the region including the front taper and the step. It is therefore capable of reducing the machining time and waste of material cost of the body.

With the method of manufacturing the cutting tool of the embodiment of the present invention, for example, in the used cutting tool whose body is deteriorated by being used for a cutting process, the portion located closer to the body can be separated by heating and melting the first front connection member, and thereafter the body member for replacement can be connected to the portion located closer to the shank by using the second front connection member. Therefore, the portion located closer to the shank, namely at least a part of the step and the shank can be used repetitively. Additionally, the step is disposed between the body and the shank, and the second front connection member is disposed in the region whose diameter is smaller than the diameter of the shank, namely the region including the body and the step, thereby reducing the machining time and waste of material cost of the body.

### BRIEF DESCRIPTION OF THE DRAWINGS

FIG. 1 (a) is a side view of a cutting tool according to an embodiment of the present invention; FIG. 1(b) is a perspective view thereof; FIG. 1(c) is a partially enlarged view thereof;

FIGS. 2(a) to 2(c) are partially enlarged views showing different types of modifications of the cutting tool of FIG. 1(c), specifically, FIG. 2(a) being a view that a front connection member is located at a step, FIG. 2(b) being a view that the front connection member is located at a front taper, FIG. 2(c) being a view that the front connection member is located at the front taper and a rear connection member is located at a rear taper;

FIGS. 3(a) to 3(c) are partially enlarged views showing different types of modifications of the cutting tool of FIG. 1(c), specifically, FIG. 3(a) being a view that a taper angle of the front taper is smaller than a taper angle of the rear taper, FIG. 3(b) being a view that the taper angle of the front taper is larger than the taper angle of the rear taper, FIG. 3(c) being a view that the taper angle of the front taper differs depending on location;

FIGS. 4(a) to 4(e) are perspective views for explaining the procedure of manufacturing the cutting tool shown in FIG. 1, specifically, FIG. 4(a) showing the process of heating a first front connection member of a cutting tool base, FIG. 4(b) showing the process of separating from each other oppositely located portions of the first front connection member, FIG. 4(c) showing the process of applying flux to a body member and a step; FIG. 4(d) showing the process of disposing a second front connection member and the process of heating and cooling the second front connection member, FIG. 4(e) showing the process of partially grinding the body member;

FIGS. 5(a) and (b) are perspective views for explaining an example of the process of separation, specifically, FIG. 5(a) showing a state of being pressed using a pressing member; FIG. 5(b) showing a state that oppositely located portions of the first front connection member are separated from each other by being pressed as shown in FIG. 5(a); and

FIG. 6 is a perspective view showing a modification of FIG. 4(c), and showing the process of applying the flux to the second front connection member.

### DETAILED DESCRIPTION OF THE PREFERRED EMBODIMENTS

<Cutting Tool>

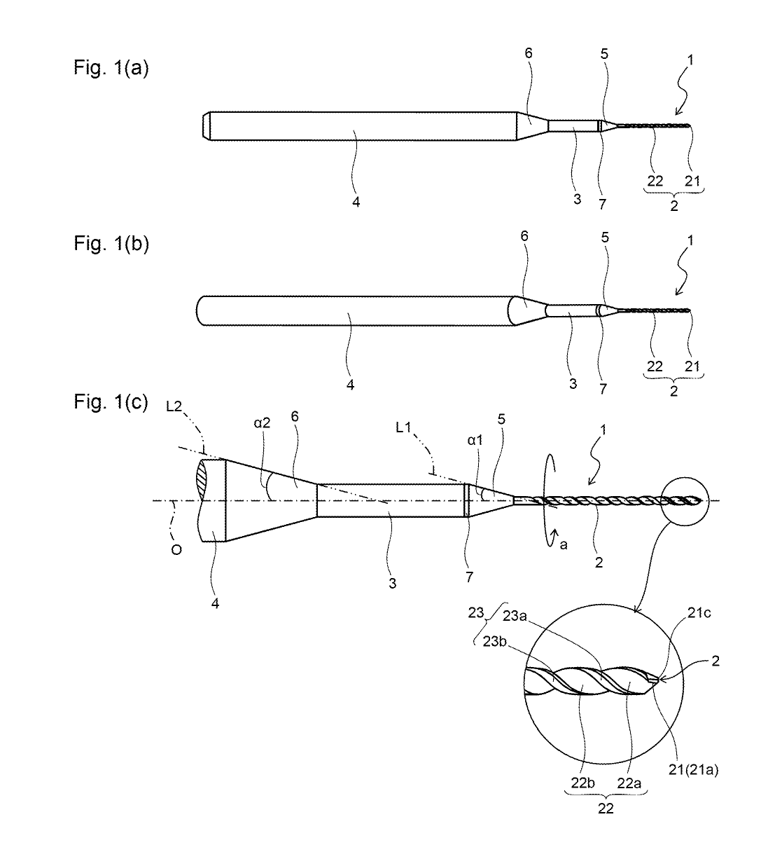

A cutting tool according to an embodiment of the present invention is described in details below with reference to FIG. 1, taking as an example a drill that is one type of cutting tool.

As shown in FIG. 1, the drill 1 of the present embodiment includes a column-like shaped body 2, a front taper 5, a column-like shaped step 3, a rear taper 6, a column-like shaped shank 4 and a front connection member 7. The body 2 has a cutting edge 21 located at a front end part thereof and a flute 22 which is located at an outer peripheral part (outer peripheral surface) thereof and is continuous with the cutting edge 21. The front taper 5 is connected to a rear end part of the body 2, and has a larger diameter as separating from the body 2. The step 3 is connected to a rear end part of the front taper 5, and has a larger diameter than the body 2. The rear taper 6 is connected to a rear end part of the step 3, and has a larger diameter as separating from the step 3. The shank 4 is connected to a rear end part of the rear taper 6, and has a larger diameter than the step 3. The front connection member 7 is located in a region including the front taper 5 and the step 3. That is, the drill 1 of the present embodiment has a structure that the diameter of the drill 1 is increased from the body 2 at the front end part thereof to the shank 4 at the rear end part thereof.

All of the body 2, the front taper 5, the step 3, the rear taper 6 and the shank 4 in the drill 1 contain a hard material. The hard material contains at least one selected from among cemented carbide, ceramics and cermet. In the present embodiment, all of the body 2, the front taper 5, the step 3, the rear taper 6 and the shank 4 are respectively formed containing cemented carbide.

The entire length of the drill 1 is preferably set at, for example, approximately 20 to 50 mm.

The drill 1 performs a cutting process of a workpiece by being rotated in a direction of arrow a around a rotation axis O, as shown in FIG. 1(c).

Individual components of the drill 1 of the present embodiment are described in order below.

(Body)

The body 2 is the column-like shaped body that is a main part for performing the cutting process by being brought into contact against the workpiece. The body 2 has the cutting edge 21 located at the front end part thereof and the flute 22 which is located at the outer peripheral part thereof and is continuous with the cutting edge 21, as described above. The body 2 of the present embodiment has a round column-like shape. That is, the body 2 has a relationship of D1=D2, where D1 is a diameter at the front end, and D2 is a diameter at a portion other than the front end in a cross section perpendicular to the rotation axis O as shown in FIG. 1(c). The diameter of the body 2 is constant from the front end to the rear end in the cross section perpendicular to the rotation axis O.

In the body 2 of the present embodiment, the radius of a shank core part around the rotation axis O, namely, the shortest distance from the rotation axis O to the flute 22 is constant from the front end to the rear end. The diameter of the body 2 is preferably set at, for example, approximately 0.05 to 0.3 mm. The length of the body 2 is preferably set at, for example, approximately 1.0 to 4.0 mm.

As shown in FIG. 1(c), the body 2 of the present embodiment has two cutting edges 21 and two flutes 22, and further has two lands 23. The cutting edges 21, the flutes 22 and the lands 23, each constituting the body 2, are described in order below.

A first cutting edge 21a and a second cutting edge 21b (not shown) that are the two cutting edges 21 are located to have 180-degree rotational symmetry on the basis of the rotation axis O (an axis). This configuration improves straight line stability during machining of the workpiece. Chips generated by the cutting edges are discharged through the flutes 22 to the rear end.

The body 2 of the present embodiment further has a chisel edge 21c located at the frontmost end thereof. The chisel edge 21c cooperates with the first cutting edge 21a and the second cutting edge 21b in cutting the workpiece, and is formed by mutually intersecting an end portion of the first cutting edge 21a and an end portion of the second cutting edge 21b which are located closer to the rotation axis O. The chips generated by the chisel edge 21c are passed via a flank surface (not shown) adjacent thereto, and are discharged through the flutes 22 to the rear end of the body 2.

A first flute 22a and a second flute 22b that are respectively the two flutes 22 are located along the rotation axis O on the outer peripheral part of the body 2 so as to correspond to the cutting edges 21, respectively. The first flute 22a and the second flute 22b are connected to the first cutting edge 21a and the second cutting edge 21b, respectively, and are extended helically from the front end to the rear end (located closer to the step 3) of the body 2.

A first land 23a and a second land 23b that are respectively the two lands 23 correspond to the outer peripheral part of the body 2, and are located on the rear end in the direction of the rotation axis O of the two flutes 22 so as to correspond to the two flutes 22, respectively. That is, the lands 23 are located at portions of the outer peripheral part of the body 2 at which the flutes 22 are not formed. The first land 23a and the second land 23b are also located between the first flute 22a and the second flute 22b on the outer peripheral part of the body 2 from the front end to the rear end part thereof.

In the present embodiment, the first flute 22a and the second flute 22b are spaced apart from each other from the front end of the body 2 to the rear end part thereof by ensuring the two lands 23 over the entire length of the body 2. Thus, the first flute 22a and the second flute 22b are not contacted with each other (joined together) over the entire length of the body 2, and hence the chips which are generated by cutting the workpiece using the cutting edges 21, and are discharged along the flutes 22 are also difficult to join together. It is therefore capable of suppressing alteration of the workpiece and deformation (surface roughness deterioration) of an inner wall of a machined hole due to heat generated from a portion clogged with the chips. It is also capable of suppressing breakage of the drill 1 due to increased stress on the portion clogged with the chips. Additionally, there is no change in the shape of the flutes, which can be caused by the joining of the flutes 22. It is therefore capable of suppressing damage to the inner wall of the machined hole due to a change in the flow of chips passing through the flutes 22.

The above-mentioned effects become remarkable, for example, when a low heat-resistant resin substrate or a composite substrate using the resin substrate is used as the workpiece. Examples of the composite substrate include a printed circuit board. The printed circuit board is a member that is formed by laminating copper foil on a glass epoxy material obtained by impregnating resin, such as epoxy resin, into glass fiber. When chips cannot be discharged smoothly in a drilling process of this type of substrate, the chips of copper foil may damage the inner wall of the machined hole, and cutting heat may be stored inside of the machined hole without being satisfactorily released. Consequently, the resin is softened to increase the roughness of the inner surface of the machined hole (the roughness of the inner wall is deteriorated). The drill 1 of the present embodiment is also suitably used for this type of printed circuit board in which the inner wall roughness is apt to increase.

(Front Taper)

The front taper 5 is connected at the front end part thereof to the rear end part of the body 2, and has the larger diameter as separating from the body 2, as described above. A taper angle α1 of the front taper 5 is preferably set at 5 to 25 degrees. The taper angle α1 denotes an angle located closer to an acute angle in an inclination angle of a virtual extension line L1 of the front taper 5 with respect to the rotation axis O of the drill 1, as shown in FIG. 1(c).

(Step)

The step 3 is connected at the front end part thereof to the rear end part of the front taper 5, and has the column-like shape having the larger diameter than the body 2, as described above. In the present embodiment, the step 3 has a round column-like shape. The diameter of the step 3 is preferably set at, for example, approximately 0.5 to 3.0 mm. The length of the step 3 needs to be set according to a desired length of the body 2, and is preferably set at, for example, approximately 3.0 to 6.0 mm.

(Rear Taper)

The rear taper 6 is connected at the front end part thereof to the rear end part of the step 3, and has the larger diameter as separating from the step 3, as described above. For example, when the drill 1 is stored in a container with a hole, the rear taper 6 has a role in storing the drill 1 in a state that the body 2 is not contacted with the container by allowing a predetermined portion of the rear taper 6 to abut against a peripheral edge of the opening of the hole. Similarly to the front taper 5, a taper angle α2 of the rear taper 6 is also preferably set at 5 to 25 degrees. The taper angle α2 denotes an angle located closer to an acute angle in an inclination angle of a virtual extension line L2 of the rear taper 6 with respect to the rotation axis O of the drill 1, as shown in FIG. 1(c). In the present embodiment, the taper angle α1 of the front taper 5 is set to be identical to the taper angle α2 of the rear taper 6.

(Shank)

The shank 4 is connected at the front end part thereof to the rear end part of the rear taper 6, and has the column-like shape having the larger diameter than the step 3, as described above. The shank 4 is fixed to a tool machine, such as a so-called chuck, and can be suitably designed according to the shape of the tool machine. In the present embodiment, the shank 4 has the round column-like shape. The diameter of the shank 4 is preferably set at, for example, approximately 1.5 to 5.0 mm. The length of the shank 4 is preferably set at, for example, approximately 15.0 to 30.0 mm.

(Front Connection Member)

The front connection member 7 is located in the region including the front taper 5 and the step 3, as described above. The front connection member 7 has a role in connecting two members (portions) to each other, and is comprised of a member (material) different from that of the two members (portions) in the present embodiment. As used herein, the region including the front taper 5 and the step 3 denotes the region including an optional portion of the front taper 5, a portion between the front taper 5 and the step 3, and an optional portion of the step 3. In the present embodiment, the front connection member 7 is located between the front taper 5 and the step 3 as shown in FIG. 1. More specifically, in the present embodiment, the front connection member 7 has a circular disk-like shape, and a front end part (surface) of the front connection member 7 has the same shape as the rear end part of the front taper 5, as shown in FIG. 1(c). This allows the front connection member 7 to exhibit excellent connection strength. The thickness of the front connection member 7 is preferably set at, for example, 0.05 to 0.20 mm. As shown in FIG. 1(c), the front connection member 7 lies along a cross section perpendicular to the rotation axis O of the drill 1. Alternatively, a part of the front connection member 7 may also be located at the front taper 5 or the step 3.

The material of the front connection member 7A is preferably a brazing filler metal. Particularly, when the two members (portions) as connection targets are cemented carbide, the brazing filler metal is preferably a silver brazing filler metal that contains silver. In the present embodiment, the melting point of the material of the front connection member 7 is set to be lower than both of the melting point of the material of the front taper 5 and the melting point of the material of the step 3. Thereby, the front taper 5 and the step 3 can be connected to each other while avoiding strength deterioration or the like due to alteration of the front taper 5 and the step 3, by melting only the front connection member 7 without softening or melting the front taper 5 and the step 3.

Thus in the drill 1 of the present embodiment, the front connection member 7 is located in the region having the smaller diameter than the diameter of the shank 4, namely, the region including the front taper 5 and the step 3, thereby reducing the machining time and material cost of the body 2. Additionally, the front connection member 7 is comprised of the member (material) different from those of the two members (portions) as the connection targets. Accordingly, for example, in the drill 1 in a state that the cutting edges 21 or the like of the body 2 are worn by being used for the cutting process of the workpiece, it is relatively easy to remove the body 2 by melting the front connection member 7 that has been used for the connection, and to replace the body 2 with a fresh one by using a fresh front connection member 7 (a later-described second front connection member 72). Hence, the components of the drill 1 which are located further closer to the shank 4 than the front connection member 7, namely, the step 3, the rear taper 6 and the shank 4 in the present embodiment can be used repetitively by replacing the body 2. On the other hand, in the case of having a welded structure that either or both of the two members are weld-integrated with each other, welded portions may be altered by heat generated during the welding. Therefore, when reused, it is necessary to remove the altered portion by cutting or the like, so that repetitively used portions of the two members may become shorter gradually. On the contrary, the drill 1 of the present embodiment is configured to include the front connection member 7 (to be heat-melted) in addition to the two connection target members. Therefore, the two connection target members are difficult to alter as described above, thus permitting repetitive use thereof.

<Various Modifications>

(Location of Front Connection Member)

Although in the foregoing embodiment the front connection member 7 is located between the front taper 5 and the step 3 as shown in FIG. 1, the front connection member 7 may be disposed as follows.

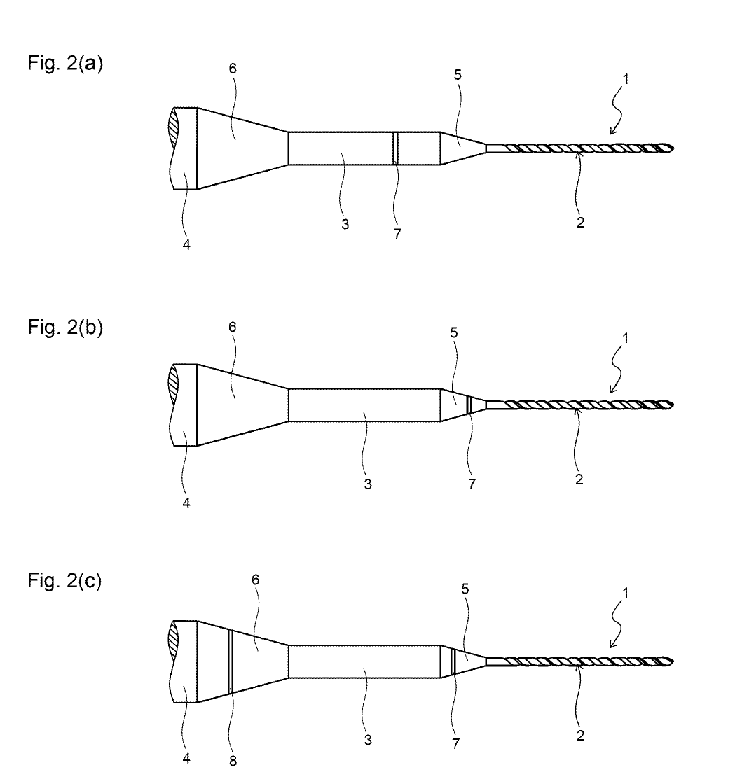

For example, as shown in FIG. 2(a), the front connection member 7 may be disposed at a portion of the step 3 located closer to the front taper 5.

Alternatively, as shown in FIGS. 2(b) and 2(c), the front connection member 7 may be disposed at a portion of the front taper 5 except for an edge located closer to the body 2, or a portion of the front taper 5 except for an edge located closer to the step 3. In case of the former, when the body 2 is replaced with a fresh one, the amount of use of the member can be reduced to improve cost reduction effect. In case of the latter, the effect obtained in the former is ensured compared to the foregoing embodiment. Further, desired connection strength can be obtained by ensuring a connection area owing to the front connection member 7. As used herein, the portion except for the edge denotes the portion where the distance from the edge is larger than the thickness of the front connection member 7.

In the present embodiment, the front connection member 7 is interposed along the cross section perpendicular to the rotation axis O of the drill 1. Alternatively, the front connection member 7 may be interposed at a predetermined inclination angle with respect to the cross section perpendicular to the rotation axis O of the drill 1. This configuration increases the contact area using the front connection member 7, thereby improving the contact strength.

(Rear Connection Member)

Although the foregoing embodiment includes the front connection member 7 as the member for connecting the two members (portions) to each other, it may further include a rear connection member 8 in addition to the front connection member 7. That is, the rear connection member 8 is located in a region including the rear taper 6 and the shank 4 as shown in FIG. 2(c). The rear connection member 8 also has a role in connecting the two members (portions), and is comprised of a member (material) different from those of the two members (portions). As used herein, the region including the rear taper 6 and the shank 4 denotes a region including an optional portion of the rear taper 6, a portion between the rear taper 6 and the shank 4, or an optional portion of the shank 4. In the present embodiment, the rear connection member 8 is located at an optional portion of the rear taper 6 as shown in FIG. 2(c). The rear connection member 8 lies along a cross section perpendicular to the rotation axis O of the drill 1.

In the present embodiment, the material of the front connection member 7 is the same as the material of the rear connection member 8. When a member connected by the front connection member 7 is different from a member connected by the rear connection member 8, both may be comprised of different materials according to the material of a connection target member. For example, the materials of the rear taper 6 and the shank 4 are different from the materials of the front taper 5 and the step 3 as in a later-described modification, a material other than the silver brazing filler metal is preferably used for the rear connection member 8 as a material that allows the two members (portions) used for the connection to be connected to each other with enhanced strength.

Thus, similarly to the front connection member 7, the rear connection member 8 is comprised of the member (material) different from those of the two members (portions) as the connection targets. Accordingly, for example, in the drill 1 in a state that a portion located at a further closer to the front end than the step 3 is deteriorated by being used for the cutting process of the workpiece, it is relatively easy to remove the body 2 and the step 3 by melting the rear connection member 8 that has been used for the connection, and to replace the body 2 and the step 3 with fresh ones using a fresh rear connection member 8. Hence, the components located further closer to the rear end than the rear connection member 8, namely, the shank 4 in the present embodiment can be used repetitively by replacing the body 2 and the step 3.

(Materials of Individual Components)

In the foregoing embodiment, all of the body 2, the front taper 5, the step 3, the rear taper 6 and the shank 4 contain the hard material. Alternatively, these individual components may be formed using the following materials.

That is, the material of the body 2 and the material of the step 3 may differ from each other. For example, cemented carbide is used for the body 2, and ceramics or steel, such as stainless steel or special purpose steel for tools, may be used for the step 3. Consequently, the material cost can be reduced than the case of using the cemented carbide for all the components.

Alternatively, the material of the step 3 and the material of the shank 4 may differ from each other. At least one of the step 3 and the shank 4 preferably contains a hard material. At least one of the step 3 and the shank 4 preferably contains ceramics. For example, ceramics may be used for the step 3, and stainless steel or special purpose steel for tools may be used for the shank 4, or vice versa. The shank 4 preferably contains steel.

When different materials are used for these individual components, preferably, the descending order of Young's modulus is the material of the body 2, the material of the step 3, and the material of the shank 4. That is, the material having the highest Young's modulus is preferably used for the body 2.

(Taper Angle)

Although in the foregoing embodiment the taper angle α1 of the front taper 5 is identical to the taper angle α2 of the rear taper 6, the taper angles α1 and α2 may be determined as follows.

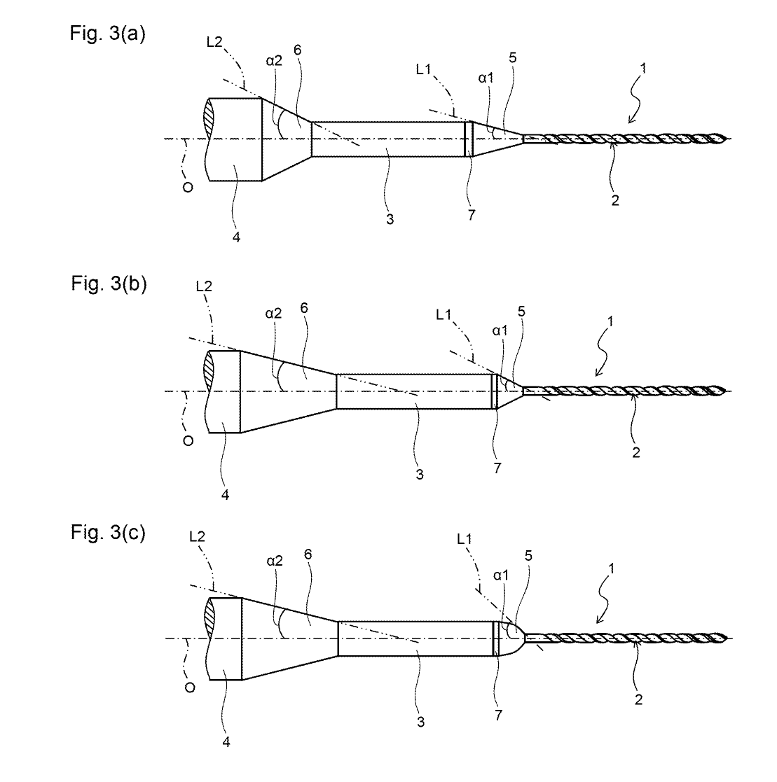

For example, as shown in FIG. 3(a), the taper angle α1 of the front taper 5 may be smaller than the taper angle α2 of the rear taper 6.

Reversely, as shown in FIG. 3(b), the taper angle α1 of the front taper 5 may be larger than the taper angle α2 of the rear taper 6.

Alternatively, as shown in FIG. 3(c), at least a portion of an outer peripheral part of the front taper 5 may have a curved surface shape in a sectional view. For example, at least a portion of the outer peripheral part of the front taper 5 may have an outwardly protruding curved surface shape in the sectional view. This configuration ensures further enhanced strength of the front taper 5 whose diameter is relatively small. Further, at least an edge of the outer peripheral part of the front taper 5 located closer to the body 2 preferably has an inwardly protruding curved surface shape in the sectional view. This configuration allows for a smooth continuity of the outer periphery of a connection part between the front taper 5 and the body 2, thereby reducing stress concentration at the connection part during the cutting process. When the taper angle is thus changed, the taper angle needs to be measured on the basis of a tangential line adjacent to the body 2.

<Method of Manufacturing Cutting Tool>

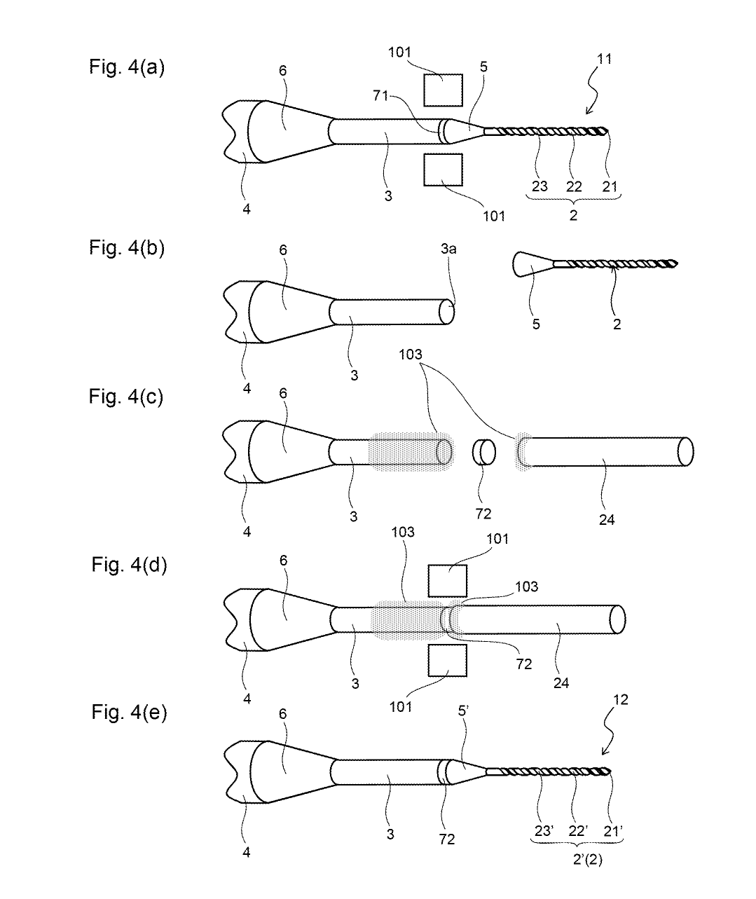

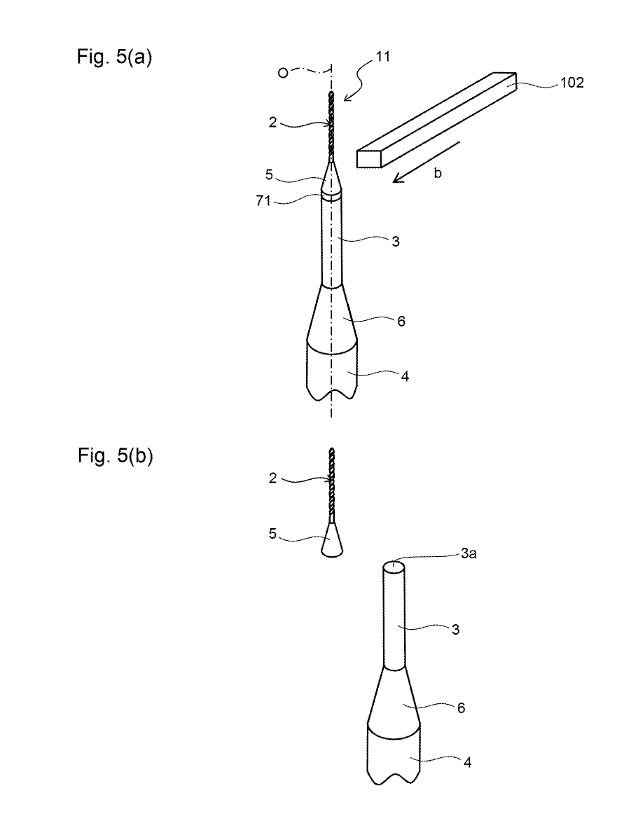

Next, a method of manufacturing a cutting tool according to an embodiment of the present invention is described in details with reference to FIGS. 4 and 5, taking the case of using the foregoing drill 1.

In the method of manufacturing the cutting tool according to the present embodiment, a drill base 11 (cutting tool base) is a member corresponding to the foregoing drill 1, and both of a first front connection member 71 and a second front connection member 72 are members corresponding to the front connection member 7 in the foregoing drill 1. In FIGS. 4 and 5, components similar to those in FIGS. 1 to 3 are identified by the same reference numerals, and descriptions thereof are omitted here.

Individual processes are described in order in details below.

(Preparation Process of Drill Base)

Firstly, the drill base 11 is prepared as shown in FIG. 4(a). The drill base 11 is a member corresponding to the drill 1 as described above, and at least one of individual components of the drill base 11 needs to be replaced with a fresh one. Some examples of the drill base 11 are a used drill 1 whose body 2 is deteriorated by being used for the cutting process, an unused drill 1 with a bad shaped body 2 attached thereto, and a drill 1 whose body 2 needs to be replaced to fit the cutting condition. The present embodiment describes the case where the drill base 11 corresponds to the used drill 1 whose body 2 is deteriorated by being used for the cutting process.

The drill base 11 of the present embodiment includes a column-like shaped body 2, a column-like shaped step 3, a column-like shaped shank 4 and a first front connection member 71. The body 2 has a cutting edge 21 located at a front end part thereof, and has a flute 22 and a land 23 that are located at an outer peripheral part thereof and are continuous with the cutting edge 21. The step 3 is connected to a rear end part of the body 2, and has a larger diameter than the body 2. The step 3 is connected to a rear end part of the front taper 5, and has a larger diameter than the body 2. The shank 4 is connected to a rear end part of the step 3, and has a larger diameter than the step 3. The first front connection member 71 is located in a region including the body 2 and the step 3. The drill base 11 of the present embodiment has a structure that a front taper 5 is interposed between the body 2 and the step 3, a rear taper 6 is interposed between the step 3 and the shank 4, and the first front connection member 71 is located between the body 2 and the step 3. Alternatively, the front taper 5 and the rear taper 6 may be omitted.

(Heating Process of First Front Connection Member)

Then, as shown in FIG. 4(a), the first front connection member 71 is heated at a temperature T1 of a melting point thereof or higher.

Specifically, the first front connection member 71 is heated using a temperature adjustment apparatus 101. Examples of the temperature adjustment apparatus 101 are ones provided with a well-known heating apparatus, such as a high frequency generator and a laser apparatus.

In the present embodiment, the melting point of the material of the first front connection member 71 is set to be lower than both of the melting point of the material of the front taper 5 and the melting point of the material of the step 3. Accordingly, by melting only the first front connection member 71 without softening or melting the front taper 5 and the step 3, the front taper 5 and the step 3 can be separated from each other in the subsequent process, while avoiding strength deterioration or the like due to alteration of the front taper 5 and the step 3. For example, the temperature T1 may be set to be lower than both of the melting point of the material of the front taper 5 and the melting point of the material of the step 3.

(Separation Process of Opposite Portions of First Front Connection Member)

Subsequently, as shown in FIGS. 4(b) and 5, oppositely located portions of the first front connection member 71 are separated from each other in a state that the first front connection member 71 is heated, namely, in a state that the temperature of the first front connection member 71 is the melting point thereof or higher.

To be specific, as shown in FIG. 5(a), at least a part of the region including the body 2 and the first front connection member 71 needs to be pressed by a pressing member 102 from a direction of arrow b perpendicular to a rotation axis O of the drill base 11. Consequently, the oppositely located portions of the first front connection member 71, namely, the portion located closer to the shank 4 and the portion located closer to the body 2 can be separated from each other.

It is particularly preferable to collectively press by the pressing member 102 the first front connection member 71 and an end portion (connection surface 3a) of the portion located closer to the shank 4 which is located closer to the first front connection member 71. That is, when the first front connection member 71 is removed in order to separate the portion located closer to the shank 4 from the portion located closer to the body 2, the pressing member 102 performs pressing so as to also touch the connection surface 3a located closer to the shank 4. Thus, the first front connection member 71 can be removed from the connection surface 3a located closer to the shank 4 by pressing once. As a result, not only the portion located closer to the body 2 but also the first front connection member 71 can be removed all together from the portion located closer to the shank 4. Consequently, the second front connection member 72 can be disposed directly on the connection surface 3a at the portion located closer to the shank 4. This simplifies the subsequent processes.

The thermal conductivity of the pressing member 102 is preferably higher than that of the step 3. For example, copper may be used for the material of the pressing member 102, and cemented carbide may be used for the material of the step 3. Thereby, the temperature of the step 3 that is already raised when the first front connection member 71 is heated in the previous process can be lowered by transferring the temperature of the step 3 to the pressing member 102 during the pressing by the pressing member 102. This reduces time needed to proceed to the subsequent process.

(Removal Process of First Front Connection Member)

The first front connection member 71 adhered to the portion located closer to the shank 4 may be removed as necessary in addition to the foregoing separation process. Thus, by performing the additional process after the separation process, the first front connection member 71 that remains as residue on the connection surface 3a in the portion located closer to the shank 4 can be removed with higher precision. As a result, a body member 24 can be more strongly connected via the second front connection member 72 to the portion located closer to the shank 4 in the subsequent process. In order to reduce the time needed to proceed to the subsequent process, the foregoing separation process and removal process are preferably at least partially carried out at the same time.

The foregoing procedure from the preparation process of the drill base to the removal process of the first front connection member can be collectively referred to as a method of removing the body from the used drill.

(Disposition Process of Body Member)

As shown in FIG. 4(c), the body member 24 is disposed at one of the separated portions which is located closer to the shank 4 by interposing the second front connection member 72 between the body member 24 and the one of the separated portions.

Hereat, the material of the first front connection member 71 needs to be identical to the material of the second front connection member 72. The second front connection member 72 needs to have a plate-like shape, such as a circular disk-like shape. Alternatively, the diameter of the second front connection member 72 may be somewhat smaller than both of the diameter of the one of the separated portions which is located closer to the shank 4, and the diameter of the body member 24. In this case, the second front connection member 72 is softened or melted and spreads in a later-described heating process of the second front connection member 72, thereby reducing the amount of material used.

(Adhesion Process of Flux)

It is preferable to add as necessary, after the separation process and before the disposition process of the body member 24, the process of allowing flux 103 to adhere to the portion located closer to the shank 4 and to at least a portion of the body member 24 opposed to the second connection member 72.

This process suppresses oxidization of the member to be heated, for example, the second front connection member 72 located between the portion closer to the shank 4 and the body member 24 in the subsequent heating process of the second front connection member 72. Hence, excellent connection strength can be ensured. A material containing fluorine or a material that enhances wettability between the second front connection member 72 and the connection surface is preferably used for the flux 103.

Further, the flux 103 is preferably also adhered to a portion of the outer peripheral part of the step 3 located closer to the body 2 (the body member 24).

(Heating Process of Second Front Connection Member)

Subsequently, the second front connection member 72 is heated at a temperature T2 of a melting point thereof or higher.

To be specific, the second front connection member 72 is heated using the temperature adjustment apparatus 101. The second front connection member 72 is preferably heated in such a manner that heat is directly applied to the second front connection member 72. This manner reduces the risk that the step 3 and the body member 24 respectively located at opposite sides of the second front connection member 72 are deformed due to unnecessary heat applied thereto. The second front connection member 72 is also preferably heated uniformly from the outer periphery thereof by using a plurality of temperature adjustment apparatuses 101.

In the present embodiment, the melting point of the material of the second front connection member 72 is preferably set to be lower than both of the melting point of the material of the front taper 5 and the melting point of the material of the step 3. Accordingly, by melting only the second front connection member 72 without softening or melting the front taper 5 and the step 3, the front taper 5 and the step 3 can be connected to each other in the subsequent process while avoiding strength deterioration or the like due to alteration of the front taper 5 and the step 3. For example, the temperature T2 may be set to be lower than both of the melting point of the material of the front taper 5 and the melting point of the material of the step 3.

The thickness of the second front connection member 72 is preferably set at, for example, 0.05 to 0.20 mm. This consequently ensures a thickness of approximately 0.03 to 0.10 mm as a thickness of the second front connection member 72, and hence achieves desired connection strength, even when there occurs a portion where the second front connection member 72 bulges somewhat further outward than the body member 24 and the step 3.

(Cooling Process of Second Front Connection Member)

Subsequently, after the heating process of the second front connection member 72, the second front connection member 72 is cooled to a temperature T3 below the melting point thereof, as shown in FIG. 4(d). This allows the one of the separated portions located closer to the shank 4 and the body member 24 to be connected to each other.

Specifically, the second front connection member 72 is cooled using the temperature adjustment apparatus 101. In the present embodiment, the temperature adjustment apparatus 101 includes a cooling mechanism. The second front connection member 72 is forcedly cooled using the cooling mechanism. Alternatively, the temperature of the second front connection member 72 may be spontaneously lowered by stopping the heating using the temperature adjustment apparatus 101 in the previous process.

(Grinding Process of Body Member)

After the cooling process, the body member 24 is partially ground as necessary, as shown in FIG. 4(e). When the body member 24 is, for example, cemented carbide, the body member 24 is preferably ground using a diamond grindinlg wheel or the like.

To be specific, the body member 24 is ground into the same shape as the body 2. That is, a new body 2′ including a cutting edge 21′, a flute 22′ and a land 23′ is formed as shown in FIG. 4(e). At least a part of the diameter of the body member 24 is smaller than the diameter of the step 3 after the grinding process. When forming the new body 2′, a front taper 5′ whose diameter increases as going toward the step 3 needs to be formed at an end portion of the body member 24 located closer to the step 3.

The diameter of the body member 24 is preferably larger than the diameter of the step 3 before the grinding process. This makes it easier to match the diameter of an end portion of the body member 24 located closer to the step 3 with the diameter of the step 3 when the body member 24 is ground into the same shape as the body 2.

The diameter of the body member 24 is preferably smaller than the diameter of the shank 4 before the grinding process. Owing to this configuration, when being replaced with the new body 2′, the amount of material of the body member 24 can be minimized to reduce the material cost.

The procedure from the disposition process of the body member to the grinding process of the body member can be collectively referred to as a method of attaching the new body to the used drill.

Thus, the new drill 12 according to the present embodiment is completed through the foregoing individual processes. These individual processes can be collectively referred to as a method of reproducing the body of the cutting tool (drill).

According to the method of manufacturing the cutting tool of the present embodiment, the used drill 1 can be repetitively reproduced as the new drill 12 by partially reusing the used drill 1.

<Various Modifications>

(Location to Adhere Flux)

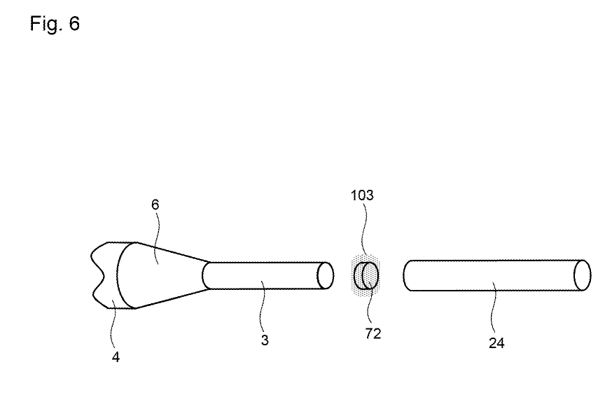

In the foregoing embodiment, the flux 103 is adhered to the portion located closer to the shank 4 and to the portion of the body member 24 which is opposed to the second front connection member 72. Alternatively, the flux 103 may be adhered to the surface of the second front connection member 72 as shown in FIG. 6. Also in this case, the second front connection member 72 preferably has a circular disk-like shape.

(Heating Process of Second Front Connection Member)

In the foregoing embodiment, the second front connection member 72 is heated in the state that the flux 103 is adhered to the circumference of the second front connection member 72. Alternatively, an inert gas may be supplied to the second front connection member 72 in the heating process of the second front connection member 72. Argon gas is preferably used as the inert gas. Similarly to the foregoing embodiment, this case also suppresses oxidization of the second front connection member 72 located between the portion located closer to the shank 4 and the body member 24, thereby ensuring excellent connection strength.

While the embodiment of the present invention and the modifications thereof have been illustrated and described, it is to be understood that the present invention is not limited to the foregoing embodiment and modifications, and other optional ones are attainable without departing from the spirit or scope of the present invention.

For example, all of the body 2, the step 3 and the shank 4 have the circular column-like shape in the foregoing embodiment. Alternatively, these components may have a taper-like shape that the radius of a shaft core part is partially or entirely increased or decreased from their respective front end to rear end. Additionally, the body 2 may have an undercut part.

In the foregoing embodiment, the brazing filler metal is exemplified as the material of the front connection member 7 and the rear connection member 8. Alternatively, a solder material may be used for at least one of these two members.

In the foregoing embodiment, the first flute 22a and the second flute 22b are independent of each other and are separated from each other from the front end to the rear end. Alternatively, the first flute 22a and the second flute 22b may be joined together on the rear end side.

In the foregoing embodiment, the body 2 is configured to have the two cutting edges 21 and the two flutes 22. Alternatively, the number of the cutting edge and the flutes may be respectively changed to, for example, one or three.

In the body 2 of the foregoing embodiment, the radius of the shank core part around the rotation axis O, namely, the minimum distance from the rotation axis O to the flutes 22 is constant from the front end to the rear end of the body 2. Alternatively, the minimum distance may be increased from the front end to the rear end thereof. In this case, the core thickness on the rear end side is increased to improve the body strength. Consequently, the drill deformation during the drilling process can be reduced, thus producing the effect of satisfactorily maintaining hole location accuracy on the printed circuit board.

The foregoing embodiment has illustrated and described, for example, the drill having the two cutting edges 21a and 21b and the two flutes 22a and 22b, in which the two flutes 22a and 22b are not contacted with each other (joined together) over the entire length of the body 2. Alternatively, the foregoing various configurations may be applied to a drill comprised of a cutting edge and a flute. Still alternatively, the two flutes may be joined to form a single flute at a predetermined position of the body. Other configurations may be similar to those in the drill 1 of the foregoing embodiment.

1. A cutting tool, comprising:
a column-like shaped body comprising a cutting edge located at a front end part thereof and a flute which is located at an outer peripheral part thereof and is continuous with the cutting edge;
a front taper connected to a rear end part of the body and having a larger diameter as separating from the body;
a column-like shaped step connected to a rear end part of the front taper and having a larger diameter than the body;
a rear taper connected to a rear end part of the step and having a larger diameter as separating from the step;
a column-like shaped shank connected to a rear end part of the rear taper and having a larger diameter than the step; and
a front connection member located in a region including the front taper and the step.

2. The cutting tool according to claim 1, wherein the front connection member is located between the front taper and the step.

3. The cutting tool according to claim 1, wherein the front connection member is located on a portion of the step located closer to the front taper.

4. The cutting tool according to claim 1, wherein a melting point of a material of the front connection member is lower than both of a melting point of a material of the front taper and a melting point of a material of the step.

5. The cutting tool according to claim 1, wherein a material of the front connection member is a brazing filler metal.

6. The cutting tool according to claim 1, wherein a taper angle α1 of the front taper is smaller than a taper angle α2 of the rear taper.

7. The cutting tool according to claim 1, wherein a material of the body and a material of the step are different from each other.

8. The cutting tool according to claim 1, wherein the body contains a hard material.

9. The cutting tool according to claim 1, wherein the shank contains steel.

10. The cutting tool according to claim 1, wherein the front taper contains a hard material.

11. The cutting tool according to claim 8, wherein the hard material contains at least one selected from among cemented carbide, ceramics and cermet.

12. A method of manufacturing a cutting tool, comprising:
preparing a cutting tool base comprising
a column-like shaped body comprising a cutting edge located at a front end part thereof and a flute which is located at an outer peripheral part thereof and is continuous with the cutting edge,
a column-like shaped step connected to a rear end part of the body and having a larger diameter than the body,
a column-like shaped shank connected to a rear end part of the step and having a larger diameter than the step, and
a first front connection member located in a region including the body and the step;
heating the first front connection member at a temperature T1 of a melting point thereof or higher;
separating from each other oppositely located portions of the first front connection member in a state that a temperature of the first front connection member is the melting point or higher;
disposing a body member at one of the portions separated from each other located closer to the shank by interposing a second front connection member between the body member and the one of the portions;
heating the second front connection member at a temperature T2 of a melting point thereof or higher; and
cooling the second front connection member at a temperature T3 below the melting point thereof after heating the second front connection member.

13. The method of manufacturing a cutting tool according to claim 12, further comprising:
partially grinding the body member after cooling the second front connection member.

14. The method of manufacturing a cutting tool according to claim 13, wherein during partial grinding of the body member, the body member is ground into a column-like shape that comprises a cutting edge located at a front end part of the body member and a flute which is located at an outer peripheral part thereof and is continuous with the cutting edge.

15. The method of manufacturing a cutting tool according to claim 13, wherein during partial grinding of the body member, a front taper having a larger diameter as going toward the step is formed at an end portion of the body member located closer to the step.

16. The method of manufacturing a cutting tool according to claim 12, wherein during separation of the oppositely located portions, at least a part of a region including the body and the first front connection member is pressed using a pressing member from a direction perpendicular to a rotation axis of the cutting tool base.

17. The method of manufacturing a cutting tool according to claim 16, wherein the first front connection member and an end portion of the portion located closer to the shank which is located closer to the first front connection member are collectively pressed by the pressing member.

18. The method of manufacturing a cutting tool according to claim 16, wherein a thermal conductivity of the pressing member is higher than a thermal conductivity of the step.

19. The method of manufacturing a cutting tool according to claim 12, wherein a material of the first front connection member and a material of the second front connection member are identical to each other.

20. The method of manufacturing a cutting tool according to claim 13, wherein a diameter of the body member is larger than a diameter of the step before partially grinding the body member.
